(19) United States
(12) Patent Application Publication
(10) Pub. No.: US 2026/0045250 A1
(43) Pub. Date: Feb. 12, 2026

(54) WEARABLE ELECTRONIC DEVICE WITH UNDERWATER AUDIO

(71) Applicant: Garmin International, Inc., Olathe, KS (US)

(72) Inventors: Matthew F. Valentine, Cary, NC (US); Bryce J. TeBeest, Olathe, KS (US); James E. Corbett, Cary, NC (US)

(21) Appl. No.: 19/276,612

(22) Filed: Jul. 22, 2025

Related U.S. Application Data
(60) Provisional application No. 63/681,575, filed on Aug. 9, 2024.

(51) Int. Cl. G10L 13/033; G01C 5/06; G08B 21/18; H04R 1/02; H04R 3/00; H04R 17/00

(52) U.S. Cl. CPC G10L 13/0335; G01C 5/06; G08B 21/18; H04R 1/028; H04R 3/00; H04R 17/00; H04R 2499/15

(57) ABSTRACT

A wearable electronic device for diving provides audio feedback underwater by using a housing that retains a piezoelectric device, a memory storing audio data, and a depth sensor. A processing element determines the current depth based on signals from the depth sensor, accesses the stored audio data, and controls the piezoelectric device to vibrate the housing. These vibrations generate audio frequency signals that radiate into the water, with the vibration pattern modulated according to the device's depth.

### RELATED APPLICATION

This application claims the benefit of U.S. Provisional Patent Application No. 63/681,575, filed Aug. 9, 2024, and entitled “Wearable Device with Underwater Audio,” the entire contents of which are incorporated herein by reference.

### BACKGROUND

GPS watches, like Garmin's Forerunner, Descent, and Fenix devices, are popular smartwatches that incorporate a variety of functions such as wellness, health, exercise, entertainment, navigation, media, communication, and other features. These features may include audio components, such as the ability to generate music, sounds, and voices that can be heard by the user. Typically, smartwatches include a conventional speaker to generate audio and/or wirelessly pair with headphones or earpods. Such conventional functionality is useful in many circumstances, but can degrade ruggedness and environmental resistance in the case of conventional speakers or become useless in the situation where the user cannot wear earpods, such as during diving or other types of exercise.

### BRIEF DESCRIPTION OF THE DRAWING FIGURES

Embodiments of the present technology are described in detail below with reference to the attached drawing figures, wherein:

FIG. 1 is a perspective view of a wearable electronic device constructed according to an embodiment of the present technology;

FIG. 2 is an environmental view of a scuba diver wearing the device of FIGS. 1-2;

FIG. 3 is a perspective view of the wearable electronic device with a display and an upper wall of a housing removed to illustrate a piezoelectric device configured to generate vibrations;

FIG. 4 is a schematic block diagram of various electronic components of the wearable electronic device; and

FIG. 5 is another example configuration of the display and piezoelectric device of the FIG. 5; and

FIG. 6 is a block diagram illustrating an example method that may be performed by embodiments of the present invention.

The drawing figures do not limit the present technology to the specific embodiments disclosed and described herein. The drawings are not necessarily to scale, emphasis instead being placed upon clearly illustrating the principles of the technology.

### DETAILED DESCRIPTION OF THE EMBODIMENTS

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the claimed subject matter. The following detailed description is, therefore, not to be taken in a limiting sense. The scope of the claimed subject matter is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

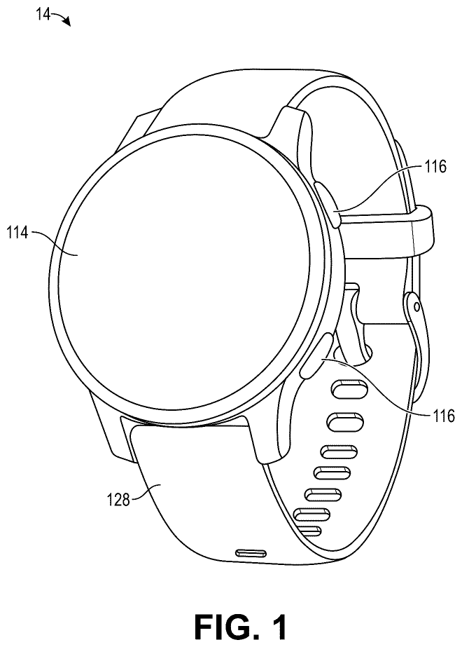

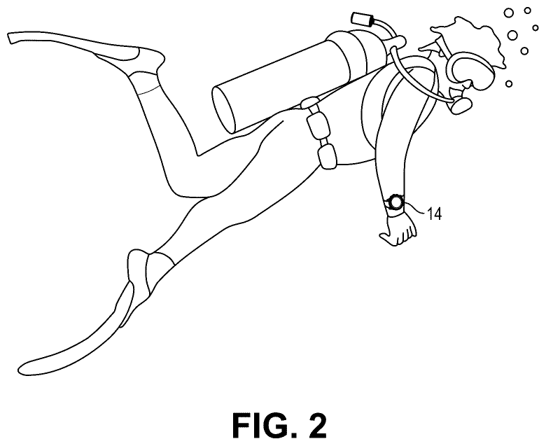

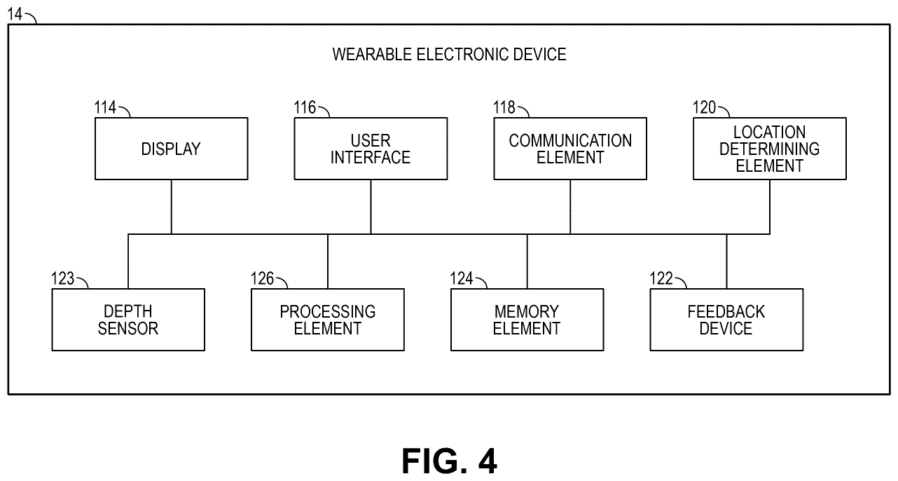

Referring to FIGS. 1-6, embodiments of the present invention provide a smartwatch with an integrated piezoelectric transducer or other feedback device that is configured to vibrate the display lens (the top cover of the watch) to generate audio sounds for reception by the user. Such functionality eliminates the need for a speaker or other port that can degrade water resistance and other environmental proofing while also providing audio without requiring the user to use headphones, earpods, or other external speakers. By vibrating the lens, as opposed to other parts of the device housing like its rear or sides, the smartwatch may retain a robust construction-such as being formed by metals or the like—without requiring compromises to the smartwatch housing itself.

In one example, a piezoelectric transducer is adhered to the bottom of the smartwatch's display stack, where the top of the display stack is the lens. Such a configuration allows the use of conventional display stacks and display and lens bonding without requiring special manufacturing or design techniques to be applied to the display stack itself. However, in other configurations, the piezoelectric transducer can be coupled with other portions of the smartwatch, or other electronic device, in addition to or as an alternative to the display.

Example configurations of the wearable electronic device 14, as shown in FIGS. 1-5, include a housing 112, a display 114, a user interface 116, a communication element 118, a location determining element 120, a feedback device 122, a depth sensor 123, a memory element 124, and a processing element 126. Although a watch-like configuration is illustrated, device 14 may take any form, including as a dive computer, dive tablet, goggles, helmet, or the like.

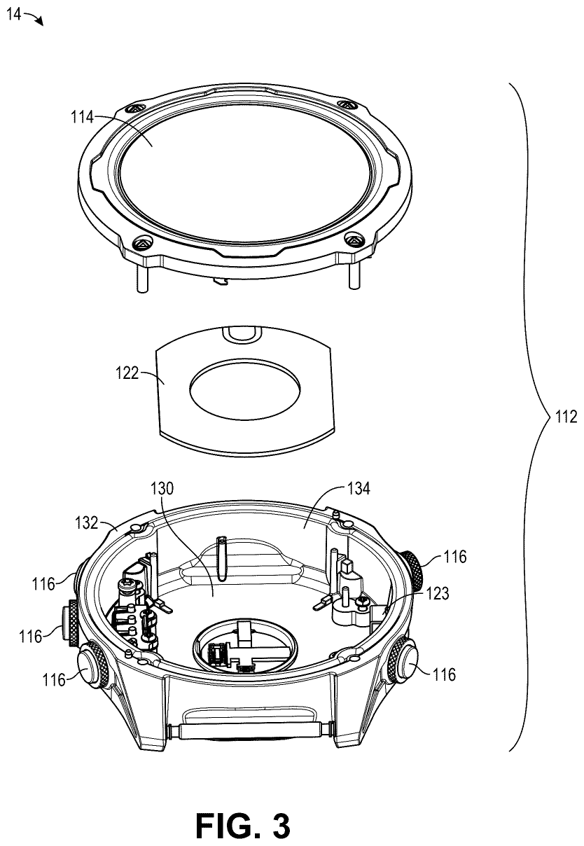

The housing 112 generally houses or retains other components of the wearable electronic device 14 and may include or be coupled to a wrist band 128. As seen in FIG. 3, the housing 112 may include a bottom wall 130, an upper wall 132, and at least one side wall 134 that bound an internal cavity. The bottom wall 130 may include a lower, outer surface that contacts the user's wrist while the user is wearing the wearable electronic device 14. In some embodiments, such as the exemplary embodiments shown in the figures, the bottom wall 130 of the housing 112 may have a round, circular, or oval shape, with a single circumferential side wall 134. In other embodiments, the bottom wall 130 may have a four-sided shape, such as a square or rectangle, or other polygonal shape, with the housing 112 including four or more sidewalls.

In some embodiments, the housing 112 of the wearable electronic device 14 is configured to achieve a high level of water resistance or full waterproofing, enabling use during recreational or professional diving activities. The elimination of traditional audio output components such as speaker ports—made possible by the integration of the feedback device 122 to generate audio through vibration of internal structures—allows the housing 112 to remain completely sealed. This sealed design enhances the device's resistance to water ingress, pressure, and particulate contamination. As a result, the housing 112 may be rated for submersion to depths consistent with established dive classifications, such as 10 ATM, 20 ATM, or greater, depending on the material and sealing approach employed.

The display 114 generally presents the information mentioned above, such as time of day, current location, and the like. The display 114 may be implemented in one of the following technologies: light-emitting diode (LED), organic LED (OLED), Light Emitting Polymer (LEP) or Polymer LED (PLED), liquid crystal display (LCD), micro-LED (uLED), thin film transistor (TFT) LCD, LED side-lit or back-lit LCD, or the like, or combinations thereof. In some embodiments, the display 114 may have a round, circular, or oval shape. In other embodiments, the display 114 may possess a square or a rectangular aspect ratio which may be viewed in either a landscape or a portrait orientation.

The user interface 116 generally allows the user to directly interact with the wearable electronic device 14 and may include a plurality of pushbuttons, rotating knobs, or the like. In various embodiments, the display 114 may also include a touch screen occupying the entire display 114 or a portion thereof so that the display 114 functions as at least a portion of the user interface 116. The touch screen may allow the user to interact with the wearable electronic device 14 by physically touching, swiping, or gesturing on areas of the display 114. The user interface 116 may be operable to receive an input representative of a desired vertical depth change notification distance. The desired vertical depth change notification distance may be a length at which a diver wants to be notified when the diver has traversed that length. For example, the diver may desire to be notified every time they ascend or descend 10 meters, and accordingly, the diver may set the desired vertical depth change notification distance to 10 meters. Additionally or alternatively, the user interface 116 may be operable to receive a selection of a rate of depth change notification threshold. The rate of depth change notification threshold may be a rate of ascent or descent. For example, the diver may desire to be notified if they are descending or ascending beyond a desired rate, such as 0.5 meters per second, and accordingly, the diver may set the rate of depth change notification threshold to 1 knot.

In some embodiments, the user interface 116 and display 114 are further operable to allow the user to configure audio feedback settings associated with the feedback device 122. Through the touchscreen portion of the display 114, the user may interact with graphical user interface elements to enable or disable voice alerts, select between different voice profiles (e.g., male or female), adjust the output volume or vibration intensity, and define specific alert conditions. For example, a diver may use the user interface 116 to set thresholds for depth-based voice notifications, choose between pre-recorded alert tones or spoken messages, or configure the device to suppress non-critical alerts during a dive. The interface may also allow users to test audio output above water to verify the clarity and volume of feedback prior to submersion. These settings may be stored in the memory element 124 and accessed by the processing element 126 to dynamically control the behavior of the feedback device 122 based on user-defined preferences.

The communication element 118 generally allows the wearable electronic device 14 to communicate with other computing devices, external systems, networks, and the like. The communication element 118 may include signal and/or data transmitting and receiving circuits, such as antennas, amplifiers, filters, mixers, oscillators, digital signal processors (DSPs), and the like. The communication element 118 may establish communication wirelessly by utilizing radio frequency (RF) signals and/or data that comply with communication standards such as cellular 2G, 3G, 4G, Voice over Internet Protocol (VoIP), LTE, Voice over LTE (VoLTE) or 5G, Institute of Electrical and Electronics Engineers (IEEE) 802.11 standard such as WiFi, IEEE 802.16 standard such as WiMAX, Bluetooth™, or combinations thereof. In addition, the communication element 118 may utilize communication standards such as ANT, ANT+, Bluetooth™ low energy (BLE), the industrial, scientific, and medical (ISM) band at 2.4 gigahertz (GHz), 5 GHz technologies, sonar or ultrasonic communication protocols, or the like. The communication element 118 may be in electronic communication with the memory element 124 and the processing element 126.

The location determining element 120 generally determines a current geolocation of the wearable electronic device 14 and may receive and process radio frequency (RF) signals from a global navigation satellite system (GNSS) such as the global positioning system (GPS) primarily used in the United States, the GLONASS system primarily used in the Soviet Union, or the Galileo system primarily used in Europe. The location determining element 120 may accompany or include an antenna to assist in receiving the satellite signals. The antenna may be a patch antenna, a linear antenna, or any other type of antenna that can be used with location or navigation devices. The location determining element 120 may include satellite navigation receivers, processors, controllers, other computing devices, or combinations thereof, and memory. The location determining element 120 may process a signal, referred to herein as a “location signal”, from one or more satellites that includes data from which geographic information such as the current geolocation is derived. The current geolocation may include coordinates, such as the latitude and longitude, of the current location of the wearable electronic device 14. The location determining element 120 may communicate the current geolocation to the processing element 126, the memory element 124, or both.

Although embodiments of the location determining element 120 may include a satellite navigation receiver, it will be appreciated that other location-determining technology may be used. In some configurations, the location determining element 120 may couple with feedback device 122 to directly or indirectly determine location. For example, location determining element 120 and feedback device 122 may be configured to receive sonar signals from known positions (e.g., beacons from fixed locations, beacons from a boat having a known location, beacons from another diver having a known location, etc.) and calculate its position based the one or more received sonar signals. In other configurations, cellular towers or any customized transmitting radio frequency towers can be used instead of satellites to determine the location of the wearable electronic device 14 by receiving data from at least three transmitting locations and then performing basic triangulation calculations to determine the relative position of the device with respect to the transmitting locations. With such a configuration, any standard geometric triangulation algorithm can be used to determine the location of the electronic device. The location determining element 120 may also include or be coupled with a pedometer, accelerometer, compass, or other dead-reckoning components which allow it to determine the location of the wearable electronic device 14. The location determining element 120 may determine the current geographic location through a communications network, such as by using Assisted GPS (A-GPS), or from another electronic device. The location determining element 120 may even receive location data directly from a user.

The feedback device 122 is operable to generate vibrations. In some examples, the feedback device 122 may be integrated with the wearable electronic device 14, such as by being retained within its housing 112. However, in other examples, the feedback device 122 may be physically separate from the wearable electronic device 14 and provide diver feedback independent of the other functions provided by the wearable electronic device 14. For instance, the feedback device 122 may be configured as a standalone pod that attaches to any part of diver, may be integrated with the diver's goggles or other equipment, etc. In such examples, the feedback device 122 may communicate with the diver's other electronic equipment, such as a diver computer or dive watch.

The vibrations provided by the feedback device 122 may include audible tones that can be heard by the diver and/or haptic vibrations that can be felt by the diver. The feedback device 122 may be operable to generate vibrations at different frequencies, such as audible tones with different pitches and/or haptic vibrations with different frequencies. Further, the feedback device 122 may be operable to generate vibrations with various amplitudes, such as louder or quieter audible tones or haptic vibrations at differing intensities. The feedback device 122 may generate continuous vibrations at one or more frequencies and/or be configured to generate vibrations only at periodic or dynamic intervals. In some examples, the feedback device 122 includes a transducer operable to generate vibratory frequencies in the audible range (audible tones) that can be heard by the diver underwater. The transducer may also or alternatively be capable of generating vibratory frequencies that may be physically perceived by the diver, such as through vibrations felt on the diver's wrist. However, the feedback device 122 may employ any haptic device, including rotational and linear mechanical weights, buzzers, and the like, to generate the vibrations described herein.

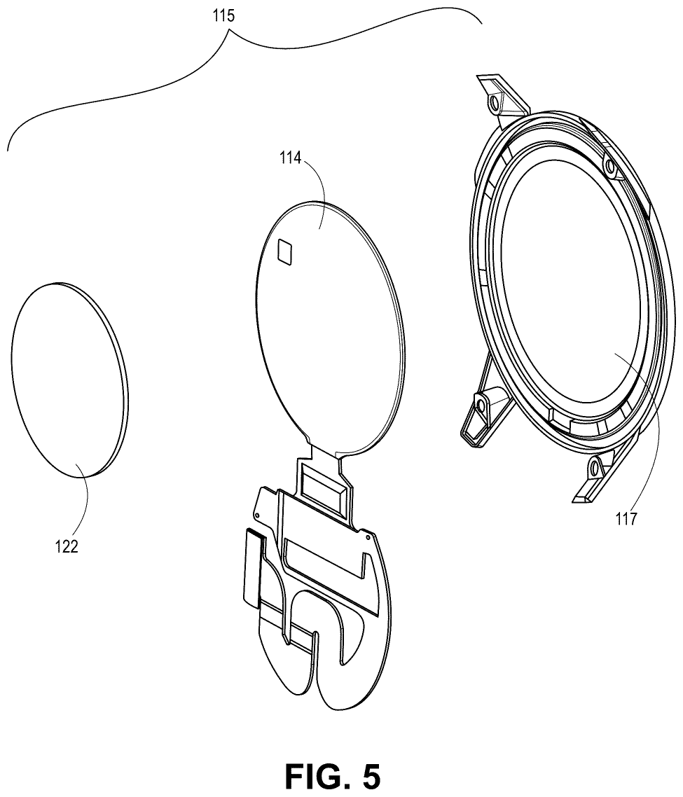

In exemplary embodiments shown in FIGS. 3 and 5, the feedback device 122 may comprise a piezoelectric device and be formed from piezoelectric material and may have a roughly planar disc shape with a central opening and diametrically opposing flat edges. The feedback device 122 may be formed from piezoelectric material, like ceramics such as lead zirconate titanate (PZT), barium titanate, lead titanate, lithium niobate, lithium tantalate, bismuth ferrite, sodium niobate, or polymers such as polyvinylidene difluoride (PVDF), which transform electrical energy into mechanical energy and vice-versa.

The feedback device 122 may function as an acoustic pressure wave transmitter or an acoustic pressure wave receiver. When operating as an acoustic pressure wave transmitter, the feedback device 122 converts electrical energy into mechanical energy. The feedback device 122 receives a transmit electronic signal as an input and emits, generates, transmits, or outputs sonar waves, such as pressure, acoustical, mechanical, and/or vibrational waves, with waveform characteristics, such as amplitude, frequency, waveshape, etc., that correspond to the waveform characteristics of the transmit electronic signal. Thus, the sonar waves may include data or other indications that are included in the transmit electronic signal. When operating as an acoustic pressure wave receiver, the feedback device 122 converts mechanical energy into electrical energy. That is, feedback device 122 receives sonar waves impinging on one or more of its surfaces and outputs or communicates a receive electronic signal with waveform characteristics that correspond to the waveform characteristics of the sonar waves. Thus, the receive electronic signal may include data or other indications that are included in the sonar waves.

The feedback device 122 can be positioned adjacent to an upper surface of the bottom wall 130 of the housing 112. While the depicted feedback device 122 is depicted as being planar, the feedback device 122 may have any shape without departing from the scope of the claimed subject matter. Additionally, the feedback device 122 may be formed of any material and comprise any type of transducer or actuator without departing from the scope of the claimed subject matter. For example, the feedback device 122 may alternatively include a motorized device with an eccentric mass attached to a motor shaft, or the feedback device 122 may include a coin shaped micro drive vibration motor.

The feedback device 122 can also transmit sonar waves in response to receiving a transmit electronic signal, wherein the waveform characteristics, such as amplitude, frequency, wave shape, etc., of the sonar waves correspond to the waveform characteristics of the transmit electronic signal. The feedback device 122 also receives sonar waves impinging on one or more of its surfaces and outputs or communicates a receive electronic signal with waveform characteristics that correspond to the waveform characteristics of the sonar waves.

The depth sensor 123 is configured to generate a signal indicative of a current depth of the housing 112. The depth sensor 123 may include a pressure transducer or similar device that is responsive to water pressure. The depth sensor 123 may receive input water pressure through a port in the housing 112. Given that the housing 112 is secured to the diver during operation of the wearable electronic device 14, the depth sensor 123 detects or senses the water pressure as experienced by the diver on a continuous or regular periodic basis. The depth sensor 123 may output a water pressure electronic signal that includes an analog electric voltage and/or electric current which varies according to a level of water pressure. Alternatively, the depth sensor 123 may include, or be in electronic communication with, an analog-to-digital converter (ADC) which converts the analog electric voltage and/or electric current to digital data, typically generated in a stream. Thus, the water pressure electronic signal may include digital data that indicates the depth of the diver. In certain embodiments, the data indicating the water pressure is included in the water pressure electronic signal on a regular, periodic basis.

In addition to or as an alternative to the pressure sensor described above, the depth sensor 123 may include other attitude, positioning, or sensing elements to generate the signal indicative of the current depth of the housing 112. For example, in some configurations, the depth sensor 123 may include an accelerometer configured to measure acceleration of the housing 112. Such acceleration information, and the corresponding signals generated by the depth sensor 123, may indicate the current depth of the housing 112 by relating to relative changes in the diver's depth. For example, zero acceleration, in one or more axes, may indicate that the diver is not changing depth. While acceleration, as a total magnitude or along one or more axes, may indicate ascent or descent. Utilizing this acceleration information, the processing element 126 can control the feedback device 122 to generate the various vibratory functionality described herein. In some configurations, the accelerometer may be utilized without requiring a pressure sensor. In other configurations, the accelerometer can be used in combination with a pressure sensor or other sensing element.

The memory element 124 may be embodied by devices or components that store data in general, and digital or binary data in particular, and may include exemplary electronic hardware data storage devices or components such as read-only memory (ROM), programmable ROM, erasable programmable ROM, random-access memory (RAM) such as static RAM (SRAM) or dynamic RAM (DRAM), cache memory, hard disks, optical disks, flash memory, thumb drives, universal serial bus (USB) drives, or the like, or combinations thereof. In some embodiments, the memory element 124 may be embedded in, or packaged in the same package as, the processing element 126. The memory element 124 may include, or may constitute, a “computer-readable medium”. The memory element 124 may store the instructions, code, code statements, code segments, software, firmware, programs, applications, apps, services, daemons, or the like that are executed by the processing element 126. The memory element 124 may be configured to store the water pressure data, depth data, ascent or descent rates, the desired vertical depth change notification distance, the rate of depth change notification threshold, or the like.

The processing element 126 may comprise one or more processors. The processing element 126 may include electronic hardware components such as microprocessors (single-core or multi-core), microcontrollers, digital signal processors (DSPs), field-programmable gate arrays (FPGAs), analog and/or digital application-specific integrated circuits (ASICs), or the like, or combinations thereof. The processing element 126 may generally execute, process, or run instructions, code, code segments, code statements, software, firmware, programs, applications, apps, processes, services, daemons, or the like. The processing element 126 may also include hardware components such as registers, finite-state machines, sequential and combinational logic, and other electronic circuits that can perform the functions necessary for the operation of the current technology. In certain embodiments, the processing element 126 may include multiple computational components and functional blocks that are packaged separately but function as a single unit. The processing element 126 may be in electronic communication with the other electronic components through serial or parallel links that include universal buses, address buses, data buses, control lines, and the like.

Thus, the processing element 126 may include, or be in electronic communication with, electronic signal processing components such as waveform generators, amplifiers, filters, ADCs, digital-to-analog converters (DACs), and the like. The processing element 126 may be operable, configured, or programmed to perform the following functions by utilizing hardware, software, firmware, or combinations thereof.

The feedback device 122 of the wearable electronic device 14 may be operable to vibrate at least a portion of the display 114 to generate audio sounds that are receivable by the user. In some configurations, the feedback device 122 vibrates a display stack 115 of display 114, like lens 117. The display stack 115 of the wearable electronic device 14 may comprise a plurality of layered components configured to provide both visual output and user interaction functionality. In some embodiments, the display stack 115 includes an OLED or AMOLED layer that serves as the primary image-generating component. Positioned above this layer is a touch panel layer, which may utilize capacitive sensing to detect user inputs such as taps, swipes, or gestures. A lamination layer may be disposed between the touch panel and the outer surface to optically bond the components, enhance durability, and reduce internal reflections. The uppermost element of the display stack 115 is the lens 117, which forms the exterior viewing surface of the display 114. The lens 117 not only provides mechanical protection and environmental sealing but may also function as the vibratory element for generating audio tones when actuated by the feedback device 122.

In one example, as shown in FIG. 5, a solid disk piezoelectric transducer may be adhered to a lower surface of the display stack 115. When driven by the processing element 126, the transducer generates mechanical vibrations that propagate upward through the layers of the display stack 115. Due to the structural continuity and coupling of the layers, these vibrations are transmitted to the lens 117, which in turn vibrates to produce acoustic waves. The lens 117 thus functions as a diaphragm, radiating sound waves into the surrounding environment. Such a configuration allows the use of conventional display stacks and display and lens bonding without requiring special manufacturing or design techniques to be applied to the display stack itself. To provide desired audio performance, the piezoelectric disk may have an outer diameter between about 25 mm and 30 mm, and in some cases a 26.5 mm OD solid disk transducer is employed. Any suitable shape of transducer may be employed to achieve the desired acoustic performance, mechanical integration, or spatial accommodation. Although a circular transducer is illustrated in certain embodiments, other shapes—such as rectangular, square, polygonal, or custom geometries—may be utilized to optimize performance, conform to the internal geometry of the housing 112, and/or integrate with the display stack 115 of the wearable electronic device 14. However, any size transducer may be employed to impart the desired vibratory signal to the display lens.

In configurations like that shown in FIG. 5, the lens 117 may be bonded to the underlying display components of the display stack 115 using LOCA (liquid optically clear adhesive) or another suitable optical bonding technique. These adhesives improve the coupling between the feedback device 122 and the display stack 115 and lens 117. By selecting appropriate adhesive configurations, the device can optimize the vibratory signal transfer, resulting in clearer and louder audio output. This approach ensures high audio quality and overall device performance during diving activities.

The feedback device 122, such as the solid disk piezoelectric transducer, may be adhered to a lower surface of the display stack 115 using double-sided tape, epoxy, or other bonding materials compatible with the device's construction. However, the feedback device 122 may be positioned anywhere in the housing, such as on a PCB shield, on or near a housing wall, and/or on another internal structure. Different lens materials can impact the audio performance of the resulting design. For example, designs using a glass lens may be louder and/or more clear than designs using a sapphire lens. In one example, a glass lens can provide a desirable SPL measurement at 3 kHz, rendering the design very suitable for siren functionality, such as that usable as an alert, alarm, or warning by the smartwatch. A sapphire lens may also be employed.

The feedback device 122 can also provide microphone functionality, where sounds imparted through the display (through the lens and display) are generated into electrical signals by the transducer. To improve microphone performance and audio processing, embodiments of the present invention may include amplifier circuitry, such as an op-amp circuit with a low noise floor, to reduce background noise while providing amplification. In a diving environment, a diver could hold the display to his or her throat to provide voice input to the wearable device 14. Additionally or alternatively, the feedback device 122 may be configured as an accessory that detaches from the device 14 to enable the feedback device 122 to be held up against the diver's throat to easily record diver speech. For instance, the feedback device 122 may be removable from the housing 112 and communicate signals to the device 14 using wired or wireless communication. The processing element 126 of the wearable electronic device 14 may interface with the feedback device 122 to transmit desired signals and process received signals. The processing element 126 may be coupled with amplifiers and other electronic circuitry to generate signals with appropriate electrical characteristics for both the transmit and receive paths associated with the feedback device 122.

In some examples, the wearable electronic device 14 is configured to generate audio signals suitable for use underwater and above water. Certain configurations may utilize the feedback device 122 to vibrate the lens 117 of the display stack 115 to produce underwater audio signals. In these configurations, the feedback device 122 may be positioned to efficiently transmit vibrational energy through the display stack 115, resulting in audible tones that can propagate in aquatic environments. Alternatively, other configurations of the wearable electronic device 14 may employ the feedback device 122 to vibrate different portions of the housing 112—such as the bottom wall 130, the side wall 134, or selected structural regions thereof—to generate underwater audio signals. These alternate configurations allow flexibility in design while still enabling effective acoustic signaling during underwater operation.

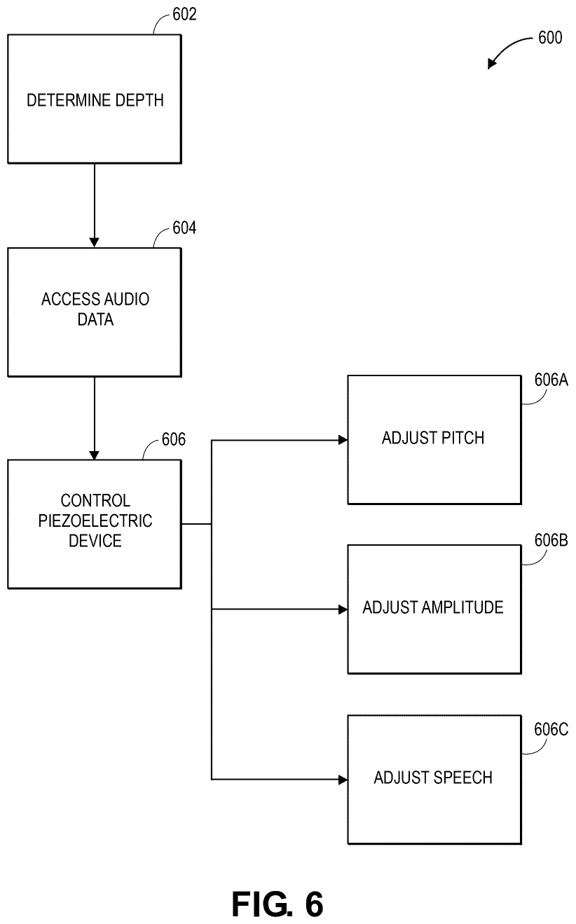

With reference to FIG. 6, an example method 600 that may be performed by embodiments of the present invention is illustrated. The method comprises a series of steps that may be executed by one or more components of the system described herein. It should be appreciated that the depicted steps are illustrative only and that additional, fewer, or alternative steps may be performed, and the order of the steps may be varied, and the steps performed simultaneously, without departing from the scope of the invention.

In step 602, the processing element 126 is configured to determine the depth of the wearable electronic device 14, and in particular its housing 112. In step 604, the processing element 126 access audio data from the memory element 124. In step 606, the processing element 126 controls the feedback device 122, such as the piezoelectric device, based on the determined depth, to vibrate the device 14 to generate audio signals for reception by the diver. As shown in Steps 606A, 606B, and 606C, in some examples, the processing element 126 can adjust the pitch, amplitude, and/or speech characteristics of the audio data to account for depth the device 14.

Referring to step 602, The processing element 126 may utilize real-time depth information provided by the depth sensor 123 to provide the optimization discussed herein or utilize other sensors and information to determine the appropriate optimization for underwater or above water use. By continuously monitoring the depth, the processing element 126 can dynamically adjust the audio parameters to maintain the best possible clarity and intelligibility of the voice alerts. This capability allows the device 14 to adapt to varying underwater conditions and ensure that the user receives accurate and understandable audio feedback at any depth.

In some embodiments, the processing element 126 determines the depth of the wearable electronic device 14 by receiving a signal from the depth sensor 123 indicative of the current depth of the housing 112. The signal may include analog or digital data representing pressure-based depth measurements. Where the signal is analog, the processing element 126 may convert it into digital data using an analog-to-digital converter. The processing element 126 then processes the received data to calculate a current depth value. In certain configurations, the signal from the depth sensor 123 may further include acceleration data, which the processing element 126 evaluates to determine relative changes in depth. The resulting depth value is stored in the memory element 124 and used to control the operation of the feedback device 122.

Referring to step 604, the processing element 126 accesses audio data from the memory element 124 by retrieving one or more stored data files or signal definitions corresponding to audio tones, alerts, text-to-speech data, or other sound patterns. The audio data may be stored in digital format, such as waveform files, compressed audio formats, or encoded signal profiles. The processing element 126 may retrieve the audio data based on predefined criteria, such as a current operational mode, user-defined settings, or detected environmental conditions.

In some embodiments, the processing element 126 is configured to generate audio data for storage in the memory element 124. The processing element 126 may create digital representations of audio signals by executing software routines (such as through a text-to-speech engine) or signal generation algorithms that define waveform characteristics such as frequency, amplitude, duration, and waveform shape. These generated signals may correspond to tones, alerts, or encoded audio patterns. Once generated, the processing element 126 formats the audio data into a storable structure and writes it to designated memory locations within the memory element 124. The stored audio data may then be indexed or tagged for future retrieval based on system events, operational states, or user inputs.

In some embodiments, the processing element 126 may access audio data by executing a text-to-speech (TTS) engine stored in the memory element 124. The processing element 126 receives or retrieves text-based input data, such as predefined phrases, alerts, or dynamically generated messages, and processes the input using the TTS engine to produce corresponding digital audio data. The TTS engine may include phoneme mapping, voice synthesis parameters, and signal generation routines that convert the textual content into waveform data suitable for audio output. Once generated, the audio data may be stored temporarily or permanently in the memory element 124.

Referring to step 606, the processing element 126 is operable to control the feedback device 122 based on the determined depth of the housing 112 to generate audio signals from the accessed audio data. Upon calculating the current depth, the processing element 126 selects appropriate audio data stored in the memory element 124 or generates such data internally. The processing element 126 then converts the selected or generated audio data into one or more transmit electronic signals with defined waveform characteristics. These signals are communicated to the feedback device 122, which responds by vibrating at specific frequencies and amplitudes to produce audible sounds. The control of the feedback device 122 by the processing element 126 may vary dynamically with changes in depth and/or other environmental characteristics, allowing the audio output to be adapted in real time.

In some embodiments, the processing element 126 is configured to adjust the pitch (step 606A), amplitude (step 606B), and/or speech characteristics (step 606C) of the accessed audio data based on the determined depth of the wearable electronic device 14. After retrieving the audio data from the memory element 124, the processing element 126 may apply one or more signal processing operations to modify the waveform characteristics of the audio data to suit current depth conditions. These operations may include frequency shifting to alter pitch, gain control to adjust amplitude, and modulation or filtering techniques to modify speech clarity or intelligibility.

In further embodiments, the processing element 126 may be configured to perform time-domain signal manipulation on the accessed audio data, including time expansion, wherein the duration of speech-based audio is elongated without altering pitch. This functionality improves intelligibility by allowing divers additional time to cognitively process critical messages, especially in acoustically challenging underwater environments. Additionally, the processing element 126 may implement redundancy techniques, selectively repeating mission-critical keywords or short phrases within a given audio message to ensure reliable comprehension, particularly in scenarios where transient environmental noise may mask portions of the original message.

To further enhance clarity, the wearable electronic device 14 may utilize a fine-tuned text-to-speech (TTS) model that is adapted to mimic the Lombard Effect—a phenomenon wherein human speakers naturally raise vocal effort and alter speech patterns in noisy conditions. By synthesizing speech with increased intensity, modified prosody, and enhanced articulation patterns, the TTS engine can produce audio signals that remain intelligible even under high-pressure or turbulent underwater conditions. In tandem, transducer optimization may be employed by the processing element 126 to constrain or shape the output waveform such that primary energy is concentrated within the optimal response band—or “sweet spot”—of the feedback device 122. This frequency-domain tailoring maximizes energy transfer efficiency and acoustic output quality

The adjustments may be based on predefined depth ranges, continuous depth measurements, detection of depth-related thresholds, or other environmental characteristics of the device 14. The modified audio data is then used to generate transmit electronic signals for driving the feedback device 122.

In some embodiments, the processing element 126 is configured to adjust the pitch, amplitude, and/or speech characteristics of the audio data by modifying parameters of the text-to-speech (TTS) engine prior to or during audio data generation. The processing element 126 may dynamically alter TTS engine settings such as voice pitch, speaking rate, volume level, intonation, and articulation style based on the determined depth of the wearable electronic device 14 or other operational conditions. The adjusted TTS output is then converted into digital audio data, stored in the memory element 124, and used to generate transmit electronic signals for actuation of the feedback device 122.

In some examples, the processing element 126 of the wearable electronic device 14 may control the feedback device 122 to produce voice alerts by actuating piezoelectric vibrations in the lens 117 of the display stack 115 or in other portions of the housing 112. These voice alerts may provide information to the diver—such as remaining air pressure, current depth, ascent or descent rate, or other dive-related metrics—through audible signals generated underwater. In some configurations, the audio alerts may be loud enough to be heard by nearby divers, thereby enabling underwater voice-based communication or group notifications. To generate these voice alerts, the processing element 126 may utilize an onboard text-to-speech (TTS) engine and/or access pre-recorded voice (PRV) messages stored in the memory element 124. These audio signals are then converted into vibratory output by the feedback device 122 for propagation through water via the vibrating lens 117 or other vibrating surfaces of the device.

The processing element 126 of the wearable electronic device 14 may optimize voice output for underwater environments by dynamically pitch-shifting audio signals, such as pre-recorded voice (PRV) messages or text-to-speech (TTS) outputs. Given that sound waves propagate more rapidly in water than in air, higher frequency components of an audio signal may become accentuated underwater, potentially distorting the perceived pitch and clarity of the message. To mitigate this effect, the processing element 126 may adjust the pitch of the audio signal downward before transmission, thereby compensating for the acoustic distortion caused by the underwater medium. This pitch adjustment ensures that the resulting audio, when generated by the feedback device 122 via vibration of the lens 117 or other structural elements of the housing 112, remains clear, intelligible, and within a frequency range more easily interpreted by the human ear during underwater activities. Pre-recorded voice (PRV) messages, along with other audio-related information such as tone libraries, alert sequences, and text-to-speech (TTS) data, may be stored in the memory element 124 of the wearable electronic device 14. These stored audio assets may be selectively accessed by the processing element 126 based on dive conditions, user preferences, or system events, enabling the generation of contextually appropriate audible alerts or voice prompts via the feedback device 122.

In some embodiments, the processing element 126 is configured to adjust the pitch and/or amplitude of the audio data based on whether the wearable electronic device 14 is operating underwater or above water. Specifically, the processing element 126 may adjust the audio data to a first pitch optimized for underwater propagation when the device is submerged, and to a second pitch better suited for airborne transmission when the device is above the water.

In addition to pitch-shifting, the processing element 126 of the wearable electronic device 14 may resample audio signals—such as pre-recorded voice (PRV) messages or text-to-speech (TTS) outputs—to play at a slower rate, effectively lengthening the pauses between words and improving intelligibility, such as through the time expansion functionality described above. Underwater, the increased speed of sound propagation can cause spoken words to sound compressed or blurred, particularly at greater depths where ambient pressure further influences sound transmission characteristics.

The processing element 126 may select either a male or female voice for audio output based on the acoustic properties of the underwater environment, where the physics of sound propagation can affect the clarity and intelligibility of the voice. Male voices, typically characterized by lower frequencies, may be more suitable for underwater use as these frequencies tend to propagate more effectively in water, with less attenuation over distance. Conversely, a female voice, with its higher frequency range, might be selected if it better matches the optimal resonance frequency of the piezoelectric transducer in specific conditions.

The processing element 126 can optimize voice output by amplifying the audio signal to increase volume underwater, addressing the challenges posed by the underwater environment. In water, background noise such as bubbles from the diver's regulator can interfere with audio signals, making it necessary for the voice output to be louder than it would be in open air. By amplifying the audio signal, the processing element 126 can ensure that the voice alerts are sufficiently loud to be heard over these ambient noises, allowing the user to receive information effectively.

Additionally, the underwater environment allows for more amplification without the typical issues associated with audio clipping. In open air, clipping can result in distortion, but underwater, where the environment has lower fidelity, such distortions are less perceptible. This permits the processing element 126 to increase volume to enhance the clarity of the voice output. By optimizing signal amplification, the device can maintain intelligible voice output in the presence of underwater noise.

The processing element 126 can re-optimize voice output as the depth increases, adjusting the audio settings to account for the changes in underwater conditions at different depths. For example, at increments such as 5, 10, 15, and 20 meters, the processing element 126 can modify the voice output to ensure that it remains clear and intelligible. These adjustments can include changes to pitch, volume, and cadence to counteract the effects of increasing pressure and the corresponding changes in sound propagation characteristics.

The processing element 126 can adjust audio settings based on the type of voice message being delivered, such as voice alerts, voice calling, or voice short messages. For voice alerts, the device may prioritize clarity and volume to ensure the user can hear critical notifications over background noise. In voice calling, the processing element 126 can adjust the audio for more natural conversation, balancing clarity with a comfortable listening volume. For voice short messages, the processing element 126 can fine-tune the pitch and cadence to enhance understandability, ensuring that brief information is conveyed clearly and efficiently. These adjustments enable the processing element 126 to optimize audio output for different types of voice communication. Additionally, based on ambient noise levels, detected by the feedback device 122 itself and/or other sensors of the device 14, the processing element 126 can adjust the amplitude of the audio signal to prioritize volume in noisy environments, including above water in air.

A surface-based Garmin SubWave communication system or other underwater communication systems—such as diver-to-diver networks, buoys, or integrated underwater communication nodes—may transmit data signals to the wearable electronic device 14. These signals may be received via sonar waves by the feedback device 122 or other components of the device 14. This information may indicate specific voice alerts to be played by the feedback device 122, such as “Return to surface,” “Depth too low,” or “I need help.” These alerts may be pre-recorded voice (PRV) messages stored in the memory element 124 or dynamically generated using a text-to-speech (TTS) engine.

The wearable electronic device 14 may also generate voice alerts based on sensor data collected locally from the device itself. For example, the processing element 126 may analyze input from the depth sensor 123 or other onboard sensors to determine when to initiate alerts related to depth thresholds, ascent rates, or critical dive metrics. Both externally received alert instructions and internally generated alert triggers may be stored in the memory element 124, allowing the processing element 126 to manage and prioritize voice outputs accordingly. This dual-source alert system ensures that the diver receives timely and contextually relevant audio feedback-both from their own physiological and environmental data and from real-time external communications.

Underwater communication systems, such as Garmin's SubWave or other surface-to-diver and diver-to-diver communication platforms, may have limited bandwidth that is insufficient for transmitting full audio messages, even when using advanced compression techniques. To address this limitation, the wearable electronic device 14 may store a comprehensive library of pre-recorded voice (PRV) messages in the memory element 124. This library, or grammar, may consist of complete phrases relevant to common or mission-critical scenarios—such as emergency procedures, dive status updates, or coordination commands—that can be selectively triggered for playback by the processing element 126 in response to data received via the feedback device 122. Alternatively, the grammar may be composed of individual pre-recorded words that the processing element 126 can dynamically assemble into ad-hoc messages. This approach allows the device to convey complex information using minimal bandwidth, by transmitting only compact symbolic representations of the desired message. In some embodiments, this method may employ encoding techniques analogous to Huffman coding, where more frequently used words are represented by shorter data strings, optimizing transmission efficiency while maintaining clarity and relevance in the delivered audio.

In some embodiments, the processing element 126 is configured to adjust the audio data for playback in above-water environments. Upon determining that the wearable electronic device 14 is located above the surface of the water—such as by evaluating depth data from the depth sensor 123 or other sensor inputs—the processing element 126 may apply one or more modifications to the audio data to optimize it for airborne transmission. These modifications may include adjusting the amplitude for increased loudness, modifying frequency content to emphasize voice clarity, or altering pitch and speech characteristics to suit above-water acoustic propagation. The adjusted audio data is then used by the processing element 126 to generate transmit electronic signals that drive the feedback device 122 to produce sound via vibration of the lens or other structural component of the device 14.

Although the technology has been described with reference to the embodiments illustrated in the attached drawing figures, it is noted that equivalents may be employed and substitutions made herein without departing from the scope of the claimed subject matter.

Having thus described various embodiments of the technology, what is claimed as new and desired to be protected by Letters Patent includes the following:

1. A wearable electronic device for providing feedback associated with a diving activity in water, the wearable electronic device comprising:
a housing;
a piezoelectric device retained by the housing;
a memory including audio data;
a depth sensor configured to generate a signal indicative of a current depth of the housing; and
a processing element in electronic communication with the piezoelectric device and the memory, the processing element configured to:
determine the current depth of the housing based on the signal from the depth sensor;
access the audio data within the memory; and
control the piezoelectric device to vibrate at least a portion of the housing, the vibration of the portion of the housing causing audio frequency signals corresponding to the accessed audio data to be radiated into the water,
wherein the processor is configured to control the vibration of the piezoelectric device based on the depth of the housing.

2. The device of claim 1, wherein the processor is configured to shift the pitch of the audio data based on the depth of the housing.

3. The device of claim 2, wherein the processor is adapted to adjust the pitch of the audio data to a first pitch when the device is below the water and a second pitch when the device is above the water.

4. The device of claim 1, wherein the processor is configured to adjust a speech cadence of the audio data based on the depth of the housing.

5. The device of claim 1, wherein the processor is configured to adjust an amplitude of the audio data based on the depth of the housing.

6. The device of claim 1, wherein the processor is configured to dynamically vary the vibration of the piezoelectric element based on changes in depth.

7. The device of claim 1, wherein the piezoelectric device is coupled to an exterior wall of the housing.

8. The device of claim 1, further including a display module retained by the housing, wherein the piezoelectric coupled with the display module to vibrate the display module to generate the audio frequency signals.

9. The device of claim 1, wherein the audio data includes voice data.

10. The device of claim 1, wherein the audio data is generated dynamically by the processor using a text-to-speech engine.

11. A wearable electronic device for providing feedback associated with a diving activity in water, the wearable electronic device comprising:
a housing;
a display module retained by the housing;
a piezoelectric device retained by the housing;
a memory including audio data;
a depth sensor configured to generate a signal indicative of a current depth of the housing; and
a processing element in electronic communication with the piezoelectric device and the memory, the processing element configured to:
determine the current depth of the housing based on the signal from the depth sensor;
access the audio data within the memory; and
control the piezoelectric device to vibrate the display module and generate audio frequency signals corresponding to the accessed audio data that are radiated into the water.

12. The device of claim 11, wherein the processor is configured to shift the pitch of the audio data based on the depth of the housing.

13. The device of claim 12, wherein the processor is adapted to adjust the pitch of the audio data to a first pitch when the device is below the water and a second pitch when the device is above the water.

14. The device of claim 11, wherein the processor is configured to adjust a speech cadence of the audio data based on the depth of the housing.

15. The device of claim 11, wherein the processor is configured to adjust an amplitude of the audio data based on the depth of the housing.

16. The device of claim 11, wherein the processor is configured to dynamically vary the vibration of the piezoelectric element based on changes in depth.

17. The device of claim 11, wherein the audio data includes voice data.

18. The device of claim 11, wherein the audio data is generated dynamically by the processor using a text-to-speech engine.
